(19) United States
(12) Patent Application Publication
(10) Pub. No.: US 2024/0328404 A1
(43) Pub. Date: Oct. 3, 2024

(54) AXIAL PISTON HYDRAULIC MACHINE HAVING A SELF-ADJUSTING SWASH PLATE

(71) Applicant: Dana Motion Systems Italia S.R.L., Reggio Emilia (IT)

(72) Inventors: Luca FONTANESI, Reggio Emilia (IT); Paolo COMODI, Reggio Emilia (IT); David GAMBUZZI, Reggio Emilia (IT)

(21) Appl. No.: 18/625,101

(22) Filed: Apr. 2, 2024

(30) Foreign Application Priority Data
Apr. 3, 2023 (DE) 20 2023 101 705.3

(51) Int. Cl. F04B 1/2078; F04B 49/24

(52) U.S. Cl. CPC F04B 1/2078; F04B 49/24

(57) ABSTRACT

The present disclosure relates to an axial piston hydraulic machine. The axial piston hydraulic machine comprises a swash plate, a first fluid port and a second fluid port. A fluidic bypass is settable that fluidically connects the first fluid port with the second fluid port, and a tilt angle of the swash plate is self-adjustable as a function of a flow cross-section of the fluidic bypass.

### CROSS REFERENCE TO RELATED APPLICATION

The present application claims priority to German Utility Model Application No. 20 2023 101 705.3, entitled “AXIAL PISTON HYDRAULIC MACHINE HAVING A SELF-ADJUSTING SWASH PLATE”, filed on Apr. 3, 2023. The entire contents of the above-identified application is hereby incorporated by reference for all purposes.

### TECHNICAL FIELD

The present disclosure relates to an axial piston hydraulic machine, more specifically to a swash plate axial piston hydraulic machine, known in the technical field as a swash plate motor or swash plate pump.

### BACKGROUND AND SUMMARY

Hydraulic machines may be configured as devices that convert the kinetic energy of a liquid to mechanical energy. In this case, the hydraulic machine may represent a hydraulic engine and the mechanical energy may drive an output shaft. Conversely, hydraulic machines may convert the mechanical energy provided by a (e.g. input) shaft to kinetic energy of a liquid. In this case, they may be referred to as hydraulic pumps.

Conventional swash plate axial piston hydraulic machines (e.g., engines or pumps) comprise a transmission shaft which can rotate about a first rotation axis, also called the transmission axis. The machine may pressurize a working fluid (for pumps), or dispense mechanical work (for engines) produced by the pressure of the working fluid.

Such conventional axial piston hydraulic machines usually comprise a cylinder block which may rotate about the same first rotation axis in accordance with the rotation of the transmission shaft. The cylinder block typically comprises a plurality of cylinders and cooperating pistons which may be arranged circumferentially about the rotation axis of the cylinder block. Usually, each piston is received in one of the cylinders, thereby forming a piston-cylinder arrangement. The pistons can move substantially axially in the cylinders between an upper stroke limit position (e.g. at maximum compression and minimum chamber volume) and a lower stroke limit position (e.g. at minimum compression and maximum chamber volume). These stroke limit positions are reached during a full rotation of the cylinder block about the first rotation axis.

Each piston may comprise a first terminal end arranged outside the respective cylinder and contacting the typically non-rotating swash plate. A chamber for holding a working fluid or liquid such as oil may be defined between each cylinder and a second terminal end of each piston arranged inside the respective cylinder. A volume of this chamber may be variable between a maximum volume (which is usually reached when the piston is in the lower stroke limit position) and a minimum volume (which is usually reached when the piston is in the upper stroke limit position). A size of these volumes may be set by a swivel angle of the swash plate which determines axial positions of the first terminal ends of the pistons (and thus axial movements of said pistons) during rotation of the cylinder block. Typically, the machine includes an actuator such as a servo piston for adjusting the swivel angle. A swivel axis typically extends orthogonally to the first rotation axis. Normally, the swash plate does not rotate about the first rotation axis.

The geometric cubic capacity of such an axial piston hydraulic machine may be defined as the sum of the single geometric cubic capacities of the cylinders/pistons mounted in the cylinder block, wherein the single geometric cubic capacity may be given by the product of the transverse cross-section of the chamber multiplied by the stroke of the piston.

Typically, each cylinder includes at least one feeding/drainage opening through which fluid may enter the chamber or leave the chamber. The at least one feeding/drainage opening may be fluidically connected to a distributor which typically comprises a working fluid distribution circuit at high pressure and a working fluid distribution circuit at low pressure.

Such distribution circuits are functionally connected to working fluid lines at high and low pressure which are outside the hydraulic machine. These working fluid lines are functionally connected to high pressure and low pressure fluid sources, respectively (e.g. pumps, reservoirs, utilities and the like).

Each distribution circuit comprises an opening that is fluidically connected to a distributor opening (e.g. a plate port) in a distributor plate. The distributor plate, which may also be referred to as a valve plate, is located axially in between the distributor and the cylinder block. Each distributor opening extends about the first rotation axis for forming a distribution arc, so that a high pressure working fluid distribution arc and a low pressure working fluid distribution arc are formed. To this end, such distribution openings usually have a circumferentially slotted shape, also known as “kidney-shaped” in the technical jargon.

A relative position of the distributor openings in the distributor plate and openings in the distributor may determine the angular sector of the rotational movement about the first rotation axis in which a fluidic connection between the respective distribution circuits and cylinder-piston arrangements are made. In more detail, during a rotation of the cylinder block, the feeding/drainage opening of each chamber faces a low pressure distribution circuit in a first range of angular positions and a high pressure distribution circuit in a second (different) range of angular positions.

Therefore, the relative (angular) position between the distribution plate and the distributor can be used to set operational characteristics of the hydraulic machine by determining the angular range in which a fluidic connection between said distribution circuits and the chambers are made.

So far, once assembled, the distribution plate and the distributor are as such stationary, for example about the first rotation axis. Therefore, these members can be moved once assembled once assembled. Rather, to alter an angular position of the distribution plate about the first rotation axis relative to the distributor, the hydraulic machine has to be disassembled. This renders the machine inoperable and requires time and skills. The fixed position of the distribution plate, however, may not enable an efficient operation of the hydraulic machine in all operating scenarios.

Accordingly, it is an object of this disclosure to improve the operational efficiency of axial piston hydraulic machines. For example, it is an object to improve said operational efficiency in a simple manner, for example without having to disassemble the axial piston hydraulic machine.

This object is solved by the subject matter according to the attached independent claim. Special embodiments are set out in this description, in the figures and in the dependent claims.

Accordingly, the presently proposed axial piston hydraulic machine comprises: a swash plate, a first fluid port and a second fluid port, wherein a fluidic bypass is settable that fluidically connects the first fluid port and the second fluid port, and wherein a tilt angle (or, put differently, a swivel angle) of the swash plate is self-adjustable as a function of a flow cross-section of the fluidic bypass. An angular range of self-adjustment can e.g. include +/−1.5° (e.g. with respect to a non-tilted and/or fully upright angular position and/or a non-self-adjusted position, e.g. prior to a self-adjustment).

Apart from the fluidic bypass and the capability of the swash plate to be self-adjustable, the hydraulic machine may, according to some embodiments, be configured similar to known solutions. Accordingly, it may e.g. comprise any of a distributor, a cylinder block, a swash plate actuator and a distributor plate as discussed above and as detailed in the following. Also, the hydraulic machine may basically operate as discussed above while in addition providing the self-adjustments disclosed herein.

The first fluid port and second fluid port may be comprised by the distributor and/or may be comprised or form a high pressure working fluid line and a low working pressure fluid line, respectively. Additionally or alternatively, the first fluid port and second fluid port may be fluidically connected to openings in the distributor that, in turn, may be fluidically connected to optional distributor arcs in an optional distributor plate.

The fluidic bypass may also be referred to as a fluidic short-circuit between the first and second fluid port, for example between a high pressure side and low pressure side that are respectively associated with the first and second fluid port. The flow cross-section of the fluidic bypass may define an extent or size of said fluidic bypass. This flow cross-section may affect the angular positions in which the pistons reach their upper and/or lower stroke limits, e.g. due to a sudden pressure change when the respective chambers receiving the pistons fluidically connect to the fluidic bypass. As a result, the reaction forces experienced by the swash plate and e.g. transmitted from the working fluid in the chambers to the pistons and from the pistons to the swash plate may vary as a function of the flow cross-section of the fluidic bypass.

Specifically, depending on the flow cross-section of the fluidic bypass, the swash plate may be exposed to a certain amount of reaction forces. These reaction forces may force the swash plate to change its position about its swivel axis. Thus, the swash plate may self-adjust its swivel angle.

Generally, this self-adjustment may include an adjustment of the swivel angle of the swash plate without additional forces having to be generated by any actuator. For instance, a swash plate actuator may be present and may be used to actively adjust said swivel angle. Yet, this actuator may not be controlled to achieve said self-adjustment and/or may be overridden by said self-adjustment. The self-adjustment may, for example, not include any feedback control or closed control loop e.g. to actively set the swivel angle of the swash plate.

By enabling the self-adjustment of the swivel angle of the swash plate, the geometric cubic capacity of the hydraulic machine may be (self-) adjusted accordingly. It has been observed that this feature may improve the overall operational efficiency of the hydraulic machine. Specifically, the swivel angle determines the volume of the fluid received and/or displaced by each chamber of the cylinder block during a rotation. By enabling a self-adjustment of the swivel angle, this fluid volume may be self-adjusted as well to reach an operationally more efficient value. Specifically and as further elaborated below, the fluid volume may be lowered at increasing loads, which may reduce a power intake and thus energy consumption by the hydraulic machine.

For example, the fluidic bypass may be settable by a distributor plate of the axial piston hydraulic machine. The distributor plate may (e.g. structurally) be configured according to known examples, but (e.g. according to the below embodiments) may be configured to vary and thereby adjust the fluidic bypass.

For example, an angular position of the distributor plate (e.g. about the first rotation axis) may be variable to vary a flow cross-section of the fluidic bypass. This angular position may e.g. be changed by a maximum of 3°. This variation may occur when operating the hydraulic machine. It may not require a disassembly of the hydraulic machine. It may not require a dedicated and e.g. electronically powered and/or controlled actuator. Rather, this variation may be driven based on hydraulic pressures, for example by pressure differences of the hydraulic working fluid. This improves efficiency of the hydraulic machine at a limited structural complexity.

According to one embodiment, the distributor plate has at least one plate port (e.g. distributor opening) that, to set the fluidic bypass, is fluidically connectable to both of the first fluid port and the second fluid port. The plate port may form a distribution arc as explained above with respect to known prior art solutions. There may be two plate ports to form two distribution arcs, wherein the distribution arcs may extend in different angular sectors of the distributor plate. For example, the distribution arcs may each comprise an angular sector of more than 40°, more than 90° and e.g. between 90° and 160°. The distribution arcs may be angularly spaced from one another.

More precisely, the plate port may be fluidically connectable to both of the first port the second fluid port simultaneously. For example, it may provide a fluidic connection between said ports while bridging a structural separation of said fluid reports. This structural separation may e.g. be comprised by the distributor and may be formed as a wall section of the distributor.

By implementing the fluidic bypass using the plate port, structural changes of the hydraulic machine compared to existing designs may be low. Also, the fluidic bypass can be reliably set and precisely adjusted.

As noted above, according to one embodiment the first fluid port and the second fluid port may be comprised by a distributor at which the distributor plate may be arranged. In other words, the first fluid port and second fluid port may be provided in a distributor of the axial piston hydraulic machine.

According to a further aspect, the axial piston hydraulic machine may have a cylinder block that is rotatable about a rotation axis and includes a plurality of cylinders with a piston being received in each cylinder. Each cylinder received may form a cylinder piston arrangement. Each cylinder and received piston may (at least partially) delimit a chamber in which fluid (e.g. a working fluid) is receivable. Each chamber may be fluidically connectable to the fluidic bypass during a rotation of the cylinder block about the rotation axis.

For example, the chambers may comprise (e.g. feeding/drainage) openings that, similar to fluidic connections formed with distribution arcs according to known prior art solutions during a rotation of the cylinder block, may fluidically connect to the fluidic bypass in at least one angular sector of the rotation. This connection may be formed through and/or by a plate port of the distributor plate as discussed above. In this manner, modifications to the components of the hydraulic machine compared to existing designs may be low. The desired transmission of reaction forces to the swash plate may thus be achieved at a low structural complexity.

Accordingly, in one example the fluidic connection (of each chamber) to the fluidic bypass is made by fluidically connecting each chamber and the plate port, e.g. at least temporarily and/or at least in one angular sector when rotating the cylinder block.

According to a further embodiment, by way of the fluidic bypass, a piston that is in a compression phase (and has e.g. not yet reached its upper stroke limit position yet) may be fluidically connected to a low pressure port out of the first fluid port and second fluid port (and simultaneously to the high pressure port out of the first fluid port and second fluid port). Additionally or alternatively, by way of the fluidic bypass, a piston that is in a suction phase (and has e.g. not yet reached its lower stroke limit position yet) is fluidically connected to a high pressure port out of the first fluid port and second fluid port (and simultaneously to the low pressure port out of the first fluid port and second fluid port).

This is contrary to existing solutions in which until reaching its respectively upper or lower stroke limit position, a fluidic connection may only be formed to one of the fluid ports. For example, in known solutions no simultaneous connection to both ports may be possible in any angular section of the rotation.

In one example, a flow cross-section of the fluidic bypass is increasable at an increasing pressure of the fluid received by one of the first fluid port and second fluid port, for example an increasing pressure of the fluid received by a high pressure port of the first and second fluid port. This pressure may e.g. be the pressure of a fluid received from the cylinder block when operating as a pump. The increasing pressure may correspond to an increasing load. By increasing the fluidic bypass at an increasing pressure and load, reaction forces exerted by the cylinder block on the swash plate may be reduced. In turn, the swash plate may adjust its swivel angle to lower a fluid displacement by the hydraulic machine. This helps to reduce a power intake of the hydraulic machine, resulting in a more efficient operation.

Accordingly, one embodiment includes that the tilt angle of the swash plate is, at an increasing pressure of the fluid received by one of the first fluid port and second fluid port and/or at an increasing flow cross-section of the fluidic bypass, self-adjustable in such a manner, so as to decrease a fluid displacement by the axial piston hydraulic machine.

A flow cross-section of the fluidic bypass may be self-adjustable. This may exclude an adjustment by any dedicated (e.g. electric) actuator, for example based on any feedback control, thereby lowering complexity. For example, no specifically controllable actuator may be present to adjust the distributor plate's angular position. Also, no specific sensor may be present to determine an angular position of the distributor plate.

Instead, the flow cross-section of the fluidic bypass may be self-adjustable as function of a fluidic pressure in at least one of the first fluid port and second fluid port. For instance, it may be self-adjustable as a function of a pressure difference between the first fluid port and second fluid port. This may provide a self-adjustment capability that is quickly and precisely adjustably to existing pressures at low complexity and at essentially no additional energy consumption.

The axial piston hydraulic machine may comprise a (for example self-adjusting) control arrangement for setting the fluidic bypass, the control arrangement being pressure driven. For example, the control arrangement may include a mechanism that, upon being driven by pressure, is configured to rotate the distributor plate. The control arrangement may only be pressure driven and may e.g. be free of any electric actuators. The control arrangement may also be referred to as a control mechanism and/or a control valve arrangement. The pressure may be a hydraulic pressure, for example of the working fluid. The control arrangement may also be referred to as a hydraulic control arrangement.

For example, the control arrangement may be fluidically connected or connectable to the one of the first fluid port and second fluid port having the higher fluidic pressure. For example, the control arrangement may be configured to automatically switch its fluidic to the one of first or second fluid port having the higher fluidic pressure, e.g. in reaction to a respective pressure change between the first and second fluid port. According to one aspect, the control arrangement may always be fluidically connected (e.g. due to having the above-discussed automatic switching capability) to the one of the first or second fluid port having the higher fluidic pressure.

The control arrangement may comprise a shuttle valve that is fluidically connected to both of the first fluid port and second fluid port. The shuttle valve may also be fluidically connected to a movable member discussed below for moving the distributor plate. Additionally or alternatively, it may be fluidically coupled to some member that is configured to set and/or adjust the fluidic bypass. The shuttle valve may be configured to fluidically connect an output port thereof (to which e.g. any of the above members may be fluidically connected) to any of the first or second fluid port and specifically to switch the fluid connection between the first or second fluid port. That is, the first fluid port and second fluid port may be alternately connected and disconnected to the output port of the shuttle valve. For example, the shuttle valve may be configured to always connect its output port to the one of the first fluid port and second fluid port having the higher fluid pressure.

The control arrangement may comprise at least one movable member that is movable as a function of a fluidic pressure applied to the movable member. This movable member may be connected e.g. to the output port of a shuttle valve as discussed above. The movable member may e.g. be rotatable or linearly movable. It may be mechanically connected to the distributor plate for, as a function of its own movement, adjusting an angular position of the distributor plate. This way, an extent of the fluidic bypass may be adjusted.

The movable member may be received in a cylinder and/or may be configured as a piston. A chamber that is at least partially delimited by the movable member and the cylinder may receive a fluid, for example the working fluid. This chamber may be fluidically coupled to the shuttle valve and/or to a control arrangement as discussed above.

The movable member may be spring-loaded into a first position. The first position may correspond to the fluidic bypass being shut. This helps to ensure a defined operating state e.g. in the absence of excessive fluid pressures at any of the first and second fluid port. Specifically, this may ensure an efficient operation at non-excessive fluid pressures at any of the first and second fluid port, given that the fluidic bypass remains shut. An excessive fluid pressure may be a pressure of the working fluid that is above a defined threshold. When the pressure is excessive, gains in efficiency by self-adjusting a tilt angle of the swash plate may outweigh potential efficiency losses resulting from opening the fluidic bypass.

Accordingly, in the first position of the movable member, a flow cross-section of the fluidic bypass may be reduced to zero. The flow cross-section may be enlargeable as a function of a movement of the movable member and/or as a function of a pressure difference between the first fluid port and the second fluid port.

For example, the axial piston hydraulic machine may include a first movable member which is a linearly displaceable member (and e.g. received in a cylinder as discussed above). Also, a second movable member may be provided which is rotatable and (e.g. mechanically) coupled with the distributor plate. When displaced, the linearly displaceable member may be configured to rotate the rotatable member. The rotatable member may be configured, when rotated, to change the angular position of the distributor plate. For example, one of the second movable member and the distributor plate may comprise a (e.g. non-circular) projection that is received in a recess in the respective other one of the second movable member and distributor plate. When rotating the second movable member, this may generate a torque that is transmitted via the coupling between the projection and recess to the distributor plate. Other mechanical connections for rotating the distributor plate can be provided as well, such as gear connections.

Embodiments of this disclosure are discussed below with reference to the attached schematic figures. Throughout the figures, recurring features are marked with same reference signs.

### BRIEF DESCRIPTION OF THE FIGURES

FIG. 1 shows a cross-sectional view of an axial piston hydraulic machine according to the prior art.

FIG. 2 shows a perspective view of a distributor comprised by an axial piston hydraulic machine according to an embodiment of the disclosure.

FIG. 3 shows a partial sectional view of the distributor of FIG. 2 in an area marked A FIG. 2.

FIG. 4 shows another partial sectional view of the distributor of FIG. 2 in an area marked B in FIG. 2.

FIG. 5 shows a detail view of the distributor of FIG. 2 in an area marked B in FIG. 2.

FIG. 6 shows a schematic view illustrating a hydraulic control arrangement for adjusting a fluidic bypass in the embodiment of FIG. 2.

### DETAILED DESCRIPTION

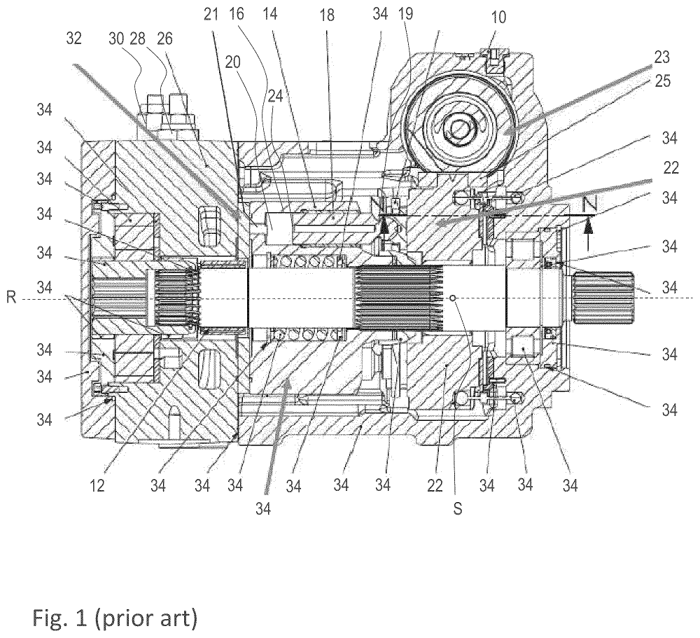

FIG. 1 depicts a cross-sectional view of an axial piston hydraulic machine 10 according to the prior art. The axial piston hydraulic machine 10 comprises a shaft 12 rotating about a rotation axis R. The cross-sectional plane of FIG. 1 comprises said rotation axis R. A cylinder block 14 is coupled to the shaft 12 for a joint rotation therewith. The cylinder block 14 comprises a plurality of cylinders 16 each receiving a piston 18. Each cylinder 16 and piston 18 form a piston cylinder arrangement and jointly delimit at least part of a chamber 20 in which a working fluid is receivable. Each chamber 20 is fluidically connected to the surroundings by an opening (or channel) 21, forming a feeing/drainage opening. A plurality of piston cylinder arrangements are regularly spaced about the rotation axis R, only one of said piston cylinder arrangements, however, being located in the sectional plane of FIG. 1.

The hydraulic machine 10 further comprises a swash plate 22. The swash plate 22 is tiltable about a swivel axis S (or tilt axis) extending orthogonally to the image plane of FIG. 1 and intersecting the rotation axis R. Accordingly, even though indicated with a substantially upright orientation in FIG. 1, the swash plate 22 can be tilted about said swivel axis S. Therefore, an upper part of the swash plate 22 in FIG. 1 to which the upper reference sign 22 points can lean forward or backward (e.g. to the left or right in FIG. 1) when adjusting a swivel angle (or tilt angle) about said swivel axis S. A lower part of the swash plate 22 in FIG. 1 to which the lower reference sign 22 points performs a respectively opposite tilting movement compared to the upper part.

The hydraulic machine 10 further comprises an actuator 23 (e.g. a hydraulically driven screw) engaging an engagement structure 25 that is coupled to the swash plate 22. This way and in a generally known manner, the tilt angle of the swash plate 22 can be actively controlled to adjust a (e.g. geometric cubic) capacity of the hydraulic machine 10.

Each piston 18 comprises a first terminal end 19 that is mechanically coupled to the swash plate 22. An opposite second terminal end 24 delimits the chamber 20. In a generally known manner and depending on the swivel angle of the swash plate 22, the piston 18 is thus axially displaced in a respective cylinder 16 along the rotation axis R when the cylinder block 14 rotates about the rotation axis R. This axial movement of the piston 18 decreases and enlarges a volume of the chamber 20.

The hydraulic machine 10 further comprises a distributor 26 that is non-rotatable about the rotation axis R, but rotatably supports the shaft 12. The distributor 26 comprises a first fluid port 28 and a second fluid port 30 as more clearly visible in the further Figures discussed below. The first fluid port 28 and second fluid port 30 may comprise (or be connected to) inner fluid channels within the distributor 26, e.g. to fluid distribution circuits of the distributor 26. One of the first and second fluid port 28, 30 forms, e.g. depending on an operation mode of the hydraulic machine 10 as a hydraulic pump or hydraulic engine, a high pressure fluid port, while the other forms a low pressure fluid port, respectively.

The hydraulic machine 10 further comprises a distributor plate 32. The distributor plate 32 is disc-shaped and axially arranged in between the cylinder block 14 and the distributor 26. It comprises a central opening through which the shaft 12 extends. However, the distributor plate 32 is not coupled to the shaft 12 for a joint rotation therewith.

The distributor plate 32 abuts against faces of the distributor 26 and the cylinder block 14, said faces facing one another. The distributor plate 32 has non-illustrated openings e.g. forming distribution arcs and through which the working fluid may pass. Specifically, these openings may fluidically couple the chamber 20 of each cylinder piston arrangement of the cylinder block 14 to the first and second fluid port 28, 30 of the distributor 26. For doing so, the openings 21 of each cylinder piston arrangement may at least one angular sector of the rotational movement of the shaft 12 fluidically coupled (via the distributor plate 32) to each of the first fluid port 28 and the second fluid port 30. This operation is generally known in the prior art and thus not further elaborated upon. Reference is made to the introductory background section of this disclosure discussing further details of this known operation.

FIG. 1 also indicates a number of other hydraulic machine components 34. These are not discussed in further detail herein.

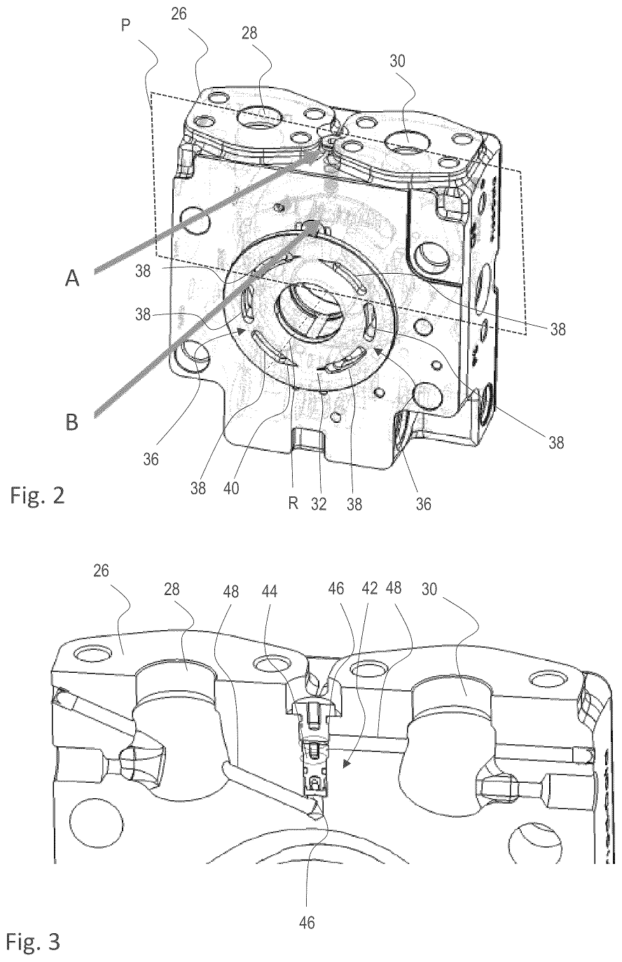

With respect to FIGS. 2-6, an embodiment according to this disclosure is discussed in the following. Only part of the hydraulic machine 10 according to this embodiment is visible in these figures. Non-illustrated components of the hydraulic machine 10 may generally be configured similar to those in FIG. 1. That is, the embodiment distinguishes over the known solution of FIG. 1, for example with respect to the distributor 26 and distributor plate 32 which are discussed in detail below. Other components of the hydraulic machine 10 may be configured and operate as shown in or similar to the example of FIG. 1.

FIG. 2 depicts a perspective view of a distributor 26 according to the embodiment of this disclosure showing a face facing a non-illustrated cylinder block and at which the distributor plate 32 is arranged. The distributor plate 32 comprises two distribution arcs 36. Each distribution arc 36 comprises a plurality of angularly spaced openings 38, which could also be provided in form of a single continuous opening. Each opening 38 may be referred to as a plate port. Each distribution arc 36 is fluidically coupled to one of the first fluid port 28 and second fluid port 30 of the distributor 26. At both of their angular outermost ends, the distribution arcs 36 (and more precisely, a respective opening 38 positioned at said end) optionally comprises a notch 40. Only one of said notches 40 is marked with a respective reference sign in FIG. 2. In a generally known manner, these notches 40 may gradually increase or decrease an extent of a fluidic coupling between the distribution arcs 36 and openings 21 of the cylinder block 14 rotating along said distribution arcs 36. This prevents sudden pressure fluctuations.

FIG. 3 depicts a sectional view of the distributor 26 in the area A of FIG. 2, the sectional plane P being marked in FIG. 2. In FIG. 3, part of a (hydraulic) control arrangement 42 is shown that enables a self-adjustment of an angular position of the distributor plate 32 about the rotation axis R and relative to the stationary distributor 26. The control arrangement 42 comprises a shuttle valve 44. Two ports 46 (e.g. input ports) of said shuttle valve 44 are shown, each port 46 being coupled to one of the first fluid port 28 or second fluid port 30 via a respective fluid channel 48. In a generally known manner, the shuttle valve 44 is configured to either fluidically connect the first fluid port 28 or the second fluid port 30 (and more specifically its respective input ports 46 to which the first and second fluid port 28, 32 are connected) to a non-illustrated output port 51 (see FIG. 6). More specifically, the shuttle valve 44 is configured to always couple that port of the first fluid port 28 and second fluid port 30 at which the higher fluidic pressure prevails to the output port 51.

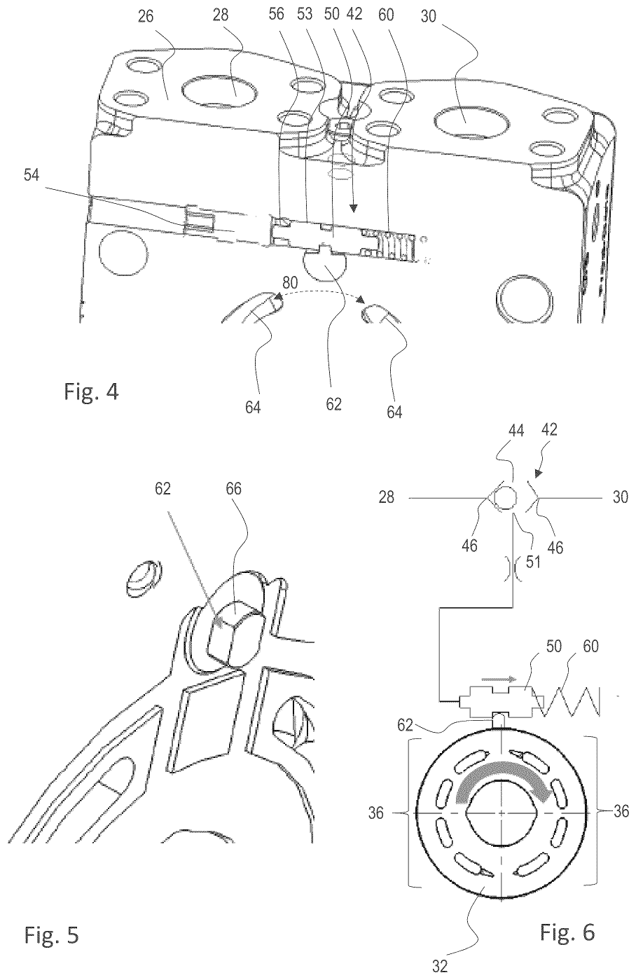

FIG. 4 depicts another sectional view of the distributor 26 in the area B of FIG. 2. A sectional plane of FIG. 4 is not specifically illustrated, but is parallel to the sectional plane P of FIG. 2 while being located closer towards the viewer.

FIG. 4 illustrates another part of the hydraulic control arrangement 42, namely a cylinder 53 receiving a linearly displaceable piston 50 (e.g. a first movable member of the hydraulic control arrangement 42). Together with an optional seal and stop member 54, the cylinder 53 and piston 50 delimit a hydraulic chamber 56 that is connected to the output port 51 of the shuttle valve 44 (see FIGS. 3 & 6). The piston 50 is spring loaded by a spring 60 into the position indicated in FIG. 4.

The piston 50 engages a second movable member 60 of the hydraulic control arrangement 42, the second movable member 60 being rotatable about a non-illustrated rotation axis extending in parallel to the rotation axis R (see e.g. FIG. 3). Thus, an angular position of the second movable member 60 is variable in accordance with a linear movement of the piston 50.

For the sake of completeness, FIG. 4 also illustrates fluid channel openings 64 at which the (in FIG. 4 non-illustrated) distributor plate 32 is arranged. These fluid channel openings 64 are each fluidically coupled with one of the first and second fluid port 28, 30 (e.g. via fluid distribution circuits of the distributor 26). This way, they establish the fluidic connection between said first and second fluid port 28, 30 and the cylinder block 14 via the distributor plate 32 and its distribution arcs 36.

FIG. 5 illustrates a detail view of the rotatable member 62 that is positioned in the area B of FIG. 2. The distributor plate 32 is not shown in FIG. 5 and the depicted face of the rotatable member 62 faces a rear side of said distributor plate 32 (e.g. faces a side thereof facing away from the viewer in FIG. 3). The rotatable member 62 comprises a projection 66 that is received in a non-illustrated recess in the rear face of the distributor plate 32. When rotating the rotatable member 62 and thus the projection 66, a torque is transmitted to the distributor plate 32 to alter an angular position of the distributor plate 32 about the rotation axis R (see FIG. 3). As a mere example, the projection 66 has a non-circular shape (for example a non-circular cross-section) which provides a particularly efficient torque transmission when rotated.

FIG. 6 is a schematic illustration of the hydraulic control arrangement 42. Again, it is shown that each input port 46 of the shuttle valve 44 is connected to one of the first and second fluid ports 28, 30. The port at which the higher fluidic pressure is present out of the first and second fluid port 28, 30 is fluidically connected to the output port 51 by the shuttle valve 44 and thus to the chamber 56 of FIG. 4. If the pressure at the connected one of the first and second fluid port 28, 30 exceeds the force of the spring 60, the piston 50 is linearly displaced, thereby rotating the only schematically illustrated rotatable member 62 to rotate the distributor plate 32. This rotation is marked by a respectively curved arrow in FIG. 6. Note that the number of openings 38 of the distribution arcs 36 depicted in FIG. 6 deviates from the respective number in FIG. 3. This, however, without relevance to the intended functioning of the hydraulic machine 10 and any number openings 38 can be provided.

As a result of the rotation, at least one of the distribution arcs 36 that is normally (e.g. when not rotated) fluidically coupled to only one of the first and second fluid ports 28, 30 is also fluidically coupled to the respectively other one of the first and second fluid port 28, 30. Referring to FIG. 4, this distribution arc 36 can e.g. be simultaneously fluidically connected to both of the fluid channel openings 64, e.g. by at least slightly overlapping with both of them. This creates a highly schematically indicated fluidic bypass 80 between the different pressure regimes, e.g. between the first and second fluid port 28, 30 and their respectively received fluid streams.

As a result, the cylinder block 14 and specifically its chambers 20 are fluidically coupled to this fluidic bypass 80 as well in at least one angular sector when rotating about the rotation axis R. This changes the normal working cycle (e.g. the linear movements and axial positions of the pistons 18 in relation to the angular positions of the cylinder block 14) when rotating the cylinder block 14.

Specifically, this results in cylinder piston arrangements that are still in a compression phase (e.g. with the piston 18 not having reached its respectively associated stroke limit yet) being already coupled to the low-pressure port out of the first and second fluid port 28, 30. Also, this results in cylinder piston arrangements that are still in a suction phase (e.g. with the piston 80 not having reached its respectively associated stroke limit yet) being already coupled to the high-pressure port out of the first and second fluid port 28, 30.

As a result, reaction forces exerted by the pistons 18 onto the swash plate 22 change. The swash plate 22, in turn, self-adjusts its tilt angle to achieve a force equilibrium adjusted to the different extent of experienced reaction forces. In order to be able to do so, the swash plate tilting mechanism comprising the actuator 23 and engagement structure 25 are designed to generate sufficiently small resistive forces. These do not withstand the self-adjusting tilting movement of the swash plates 22. For example, a self-locking effect of the engagement between the actuator 23 and the engagement structure 25 may be deliberately weak. In one example, the forces exerted onto the swash plate 22 that overcome the resistive forces of actuator 23 and engagement structure 25 for achieving the swash plate's 22 self-adjustment are between 1000 N and 2500 N, e.g. between 1800 N and 2200 N.

An operation of the hydraulic machine 10 according to the embodiment of this disclosure may be as follows: In a first operation mode without any self-adjustments, the port at which the higher fluidic pressures is present out of the first and second fluid port 28, 30 is fluidically coupled to the output port 51 of the shuttle valve 44. As long as the pressure at this port is too low to compress the spring 60 of FIG. 4, the distributor plate 32 remains in its initial angular position of FIG. 6 in which no fluidic bypass 80 is generated. In this state, each distribution arc 36 of the distributor plate 32 is fluidically coupled to only one of the first and second fluid port 28, 30.

When the pressure at the one of the first and second fluid port 28, 30 that is fluidically coupled to the output port 51 increases above a threshold, the piston 50 of FIG. 4 is linearly displaced while compressing the spring 60. This translates into a rotation of the rotatable member 62, thereby rotating the distributor plate 32 about the rotation axis R. At a sufficiently large rotation, one of the distribution arcs 36 of the distributor plate 32 is fluidically coupled to both of the first and second fluid port 28, 30, thereby generating the fluidic bypass 80. The higher the pressure at the one of the first and second fluid port 28, 30 that is fluidically coupled to the output port 51, the larger a flow cross-section of this fluidic bypass 80.

Note that the flow cross-section of the fluidic bypass 80 is set in a self-adjusting manner and only by being hydraulic-pressure driven. No operation of any dedicated non-hydraulic actuators is required.

As a result of the fluidic bypass 80 being established, the above discussed self-adjustment of the tilt angle of the swash plates 22 may set in. The extent of this self-adjustment is a function of flow cross-section of the fluidic bypass 80. This adjustment may take place in such a manner, so that a fluid displacement by each piston 18 of the cylinder block 14 and thus of the overall hydraulic machine 10 is reduced. This lowers energy consumption of the hydraulic machine 10, thereby enabling a more efficient operation. Again, this is achieved in a self-adjusting manner and only by being hydraulic-pressure driven. No dedicated operation of the actuator 23 of FIG. 1 or of any other non-hydraulic actuator is required.

Further, the above disclosed self-adjustment functionalities for setting a cross-section of the fluidic bypass 80 and for adjusting a tilting angle of the swash plate 22 do not require any sensors or sophisticated feedback control loops.

### LIST OF REFERENCE SIGNS

10 hydraulic machine
12 shaft
16 cylinder
18 piston
19 first terminal end
20 chamber
21 opening
22 swash plate
23 actuator
25 engagement structure
24 second terminal end
26 distributor
28 first fluid port
30 second fluid port
32 distributor plate
34 machine component
36 distribution arc
38 opening/plate port
40 notch
42 control arrangement
44 shuttle valve
46 input port
48 fluid channel
50 piston/first movable member
53 cylinder
54 seal and stop member
56 chamber
60 spring
62 rotatable member/second movable member
64 fluid channel opening
66 projection
80 fluidic bypass
R rotation axis
S swivel axis
P sectional plane
A, B areas of FIG. 2 depicted in greater detail in other Figures

1. An axial piston hydraulic machine, comprising:
a swash plate, a first fluid port and a second fluid port,
wherein a fluidic bypass is settable that fluidically connects the first fluid port with the second fluid port, and
wherein a tilt angle of the swash plate is self-adjustable as a function of a flow cross-section of the fluidic bypass.

2. The axial piston hydraulic machine of claim 1, wherein the fluidic bypass is settable by a distributor plate of the axial piston hydraulic machine.

3. The axial piston hydraulic machine of claim 2, wherein an angular position of the distributor plate is variable to vary a flow cross-section of the fluidic bypass.

4. The axial piston hydraulic machine of claim 2, wherein the distributor plate has at least one plate port that, to set the fluidic bypass, is fluidically connectable to both of the first fluid port and the second fluid port.

5. The axial piston hydraulic machine of claim 1, wherein the first fluid port and second fluid port are provided in a distributor of the axial piston hydraulic machine.

6. The axial piston hydraulic machine of claim 1, wherein the axial piston hydraulic machine has a cylinder block that is rotatable about a rotation axis and includes a plurality of cylinders with a piston being received in each cylinder, each cylinder and received piston at least partially delimiting a chamber in which fluid is receivable, each chamber being fluidically connectable to the fluidic bypass during a rotation of the cylinder block about the rotation axis.

7. The axial piston hydraulic machine of claim 4, wherein the connection to the fluidic bypass is made by fluidically connecting each chamber and the plate port.

8. The axial piston hydraulic machine of claim 6, wherein by way of the fluidic bypass, a piston that is in a compression phase is fluidically connected to a low pressure port out of the first fluid port and second fluid port and/or a piston that is in a suction phase is fluidically connected to an high pressure port out of the first fluid port and second fluid port.

9. The axial piston hydraulic machine of claim 1, wherein a flow cross-section of the fluidic bypass is increasable at an increasing pressure of the fluid received by one of the first fluid port and second fluid port.

10. The axial piston hydraulic machine of claim 1, wherein the tilt angle of the swash plate is, at an increasing pressure of the fluid received by one of the first fluid port and second fluid port and/or at an increasing flow cross-section of the fluidic bypass, self-adjustable such as to decrease a fluid displacement by the axial piston hydraulic machine.

11. The axial piston hydraulic machine of claim 1, wherein a flow cross-section of the fluidic bypass is self-adjustable.

12. The axial piston hydraulic machine of claim 10, wherein the flow cross-section of the fluidic bypass is self-adjustable as function of a fluidic pressure in at least one of the first fluid port and second fluid port.

13. The axial piston hydraulic machine of claim 1, wherein the axial piston hydraulic machine comprises a control arrangement for setting the fluidic bypass, the control arrangement being pressure driven.

14. The axial piston hydraulic machine of claim 13, wherein the control arrangement is fluidically connected or connectable to the one of the first fluid port and second fluid port having the higher fluidic pressure.

15. The axial piston hydraulic machine of claim 13, wherein the control arrangement comprises a shuttle valve that is fluidically connected to both of the first fluid port and second fluid port.

16. The axial piston hydraulic machine of claim 13, wherein the control arrangement comprises at least one movable member that is movable as a function of a fluidic pressure applied to the movable member.

17. The axial piston hydraulic machine of claim 16, wherein the movable member is spring-loaded into a first position.

18. The axial piston hydraulic machine of claim 17, wherein in the first position, a flow cross-section of the fluidic bypass is reduced to zero.

19. The axial piston hydraulic machine according of claim 2, wherein a first movable member is provided which is a linearly displaceable member and a second movable member is provided which is rotatable and coupled with the distributor plate, wherein the first movable member is, when linearly displaced, configured to rotate the second movable member, and wherein the second movable member, when rotated, is configured to change the angular position of the distributor plate.
